(19) United States
(12) Patent Application Publication
(10) Pub. No.: US 2002/0104046 A1
(43) Pub. Date: Aug. 1, 2002

(54) Method and system for automatically testing a universal serial bus peripheral design

(76) Inventors: Saleem C. Mohammad, Fremont, CA (US); Sunil Goje, Sunnyvale, CA (US)

Correspondence Address: WILDMAN, HARROLD, ALLEN & DIXON, 225 WEST WACKER DRIVE, CHICAGO, IL, 60606, US

(21) Appl. No.: 09/774,444

(22) Filed: Jan. 31, 2001

(51) Int. Cl. G06F 11/26

(52) U.S. Cl. 714/43

(57) ABSTRACT

A method and system for automatically testing a universal serial bus (USB) design for a plurality of test environments is provided. A user may be queried for information regarding the USB design being tested. One of a plurality of test environments is then automatically selected to be tested. The selected test environment is then used to test the universal serial bus design. The steps are then repeated for a desired number of test environments. The steps may be repeated until the universal serial bus design has been tested for all of the plurality of test environments. A system is provided for testing a USB design includes a query unit which queries a user for information regarding the universal serial bus design. A test configuration module automatically tests the universal serial bus design for a plurality of test configurations based on the information regarding the universal serial bus design.

### BACKGROUND

The present invention relates generally to methods for testing universal serial bus (USB) designs and, more particularly, to a method for automatically testing USB designs for one or more test configurations.

The universal serial bus (USB) is used as a hardware interface for relatively low speed peripherals, such as a keyboard, mouse, scanner, printer and the like. USB peripheral designs can be implemented with different configurations and different end points. Before a chip is released, the USB peripheral design is tested for functionality and protocol using hardware descriptive language (HDL) code. By manually editing test vectors, a user may select different test environments to test different configurations.

Unfortunately, this manual testing process takes time and is susceptible to errors. For example, the user may provide the wrong test variables. In addition, the testing process is sequence sensitive. Thus, if the user edits the test variables in the wrong sequence, the testing process may fail. If the testing process is not performed correctly, the user may test the USB peripheral design using the wrong set of environment variables which can result in a false, or faulty, design. Accordingly, there is a need for a method for automatically testing a USB peripheral design in a variety of different configurations in which the test variables, or test environment, is substantially automatically modified and in which the design is tested for an automatic sequence of test environments.

### SUMMARY

This need is met by a method and system in accordance with the present invention in which a USB design is automatically tested for multiple test environments, or configurations.

In accordance with one aspect of the present invention, a method for automatically testing a universal serial bus design is provided. The method automatically selects one of a plurality of test environments to be tested. The selected test environment is then used to test the universal serial bus design. The steps are then repeated for a desired number of test environments. The steps may be repeated until the universal serial bus design has been tested for all of the plurality of test environments. Different variables depicting the test environments may be selected or changed. For example, and not limitation, end point values, configuration values, alternate setting values and interface values may be selected.

Test reports may be provided to a user. The test results may be reported substantially immediately if one of the selected test environments fails. Alternatively, or additionally, the test results may be reported after all of the test environments have been tested.

In accordance with another aspect of the present invention, a method for automatically testing a universal serial bus design is provided. A user is queried for information regarding the universal serial bus design. One of a plurality of test configurations for the universal serial bus design are automatically selected based on the information provided by the user. The universal serial bus design is then tested for the selected one of the test configurations. Another one of the test configurations for the universal serial bus design is then automatically selected. The universal serial bus design is tested for the other one of the test configurations.

In accordance with yet another aspect of the present invention, a system for testing a universal serial bus design is provided. A query unit queries a user for information regarding the universal serial bus design. A test configuration module automatically tests the universal serial bus design for a plurality of test configurations based on the information regarding the universal serial bus design. The test configuration module may comprise a configuration unit for setting a configuration value for each of the test configurations. An interface unit may be provided for setting an interface value for each of the test configurations. An end point unit may set an end point value for each of the test configurations. The test configuration module may include an alternate setting unit for setting an alternate setting value for each of the test configurations. A report unit reports test results for the test configurations. The report unit may report test results after each test configuration is tested.

These and other features and advantages of the present invention will become apparent from the following detailed description, the accompanying drawings and the appended claims.

### BRIEF DESCRIPTION OF THE DRAWINGS

The foregoing and other advantages of the invention will become apparent upon reading the following detailed description and upon reference to the drawings in which:

FIG. 1 is flowchart illustrating a method for automatically testing a USB design for a plurality of test environments, or configurations, in accordance with one aspect of the present invention;

FIG. 2 is a graphical representation of test environments used in the method illustrated in FIG. 1;

FIG. 3 is a graphical representation of a test configuration which may be implemented in the method shown in FIG. 1;

FIG. 4 is a graphical representation of another test configuration which may be implemented in the method shown in FIG. 1;

FIG. 5 is a flowchart of a method in accordance with another aspect of the present invention for automatically testing a USB design for a plurality of test environments; and

FIG. 6 is a block diagram of a system for automatically testing a USB design for a plurality of test environments.

### DETAILED DESCRIPTION

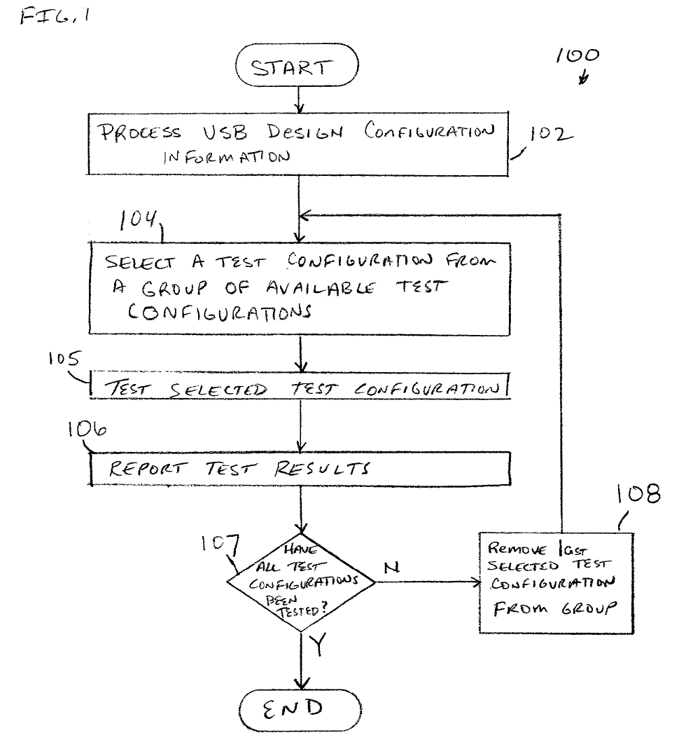

A method 100 for testing a universal serial bus (USB) design in accordance with the present invention is shown in FIG. 1. The method 100 processes the USB design configuration information for a particular USB design being tested in step 102. One of a group of available test configurations, or test environments, is then automatically selected in step 104. The test environment may be comprised of a number of test variables. For example, test variables may consist of configuration number, interface, bulk in end point and alternate setting. Other test variables may be used and should be considered in accordance with the present invention.

The USB design is tested using the selected test configuration in step 105. At step 106, test results (pass or fail) are reported. For the version of the present invention shown in FIG. 1, the test results are reported after each test configuration is tested. However, the test results may be reported, alternatively or in addition, after all the test configurations have been tested.

At step 107, it is determined whether all the test configurations have been tested. If not, the method 100 advances to step 108 where the last selected test configuration is removed from the group of test configurations. The method 100 then returns to step 104 and another test configuration is selected and tested. As will be discussed more fully below, the sequence in which the test configurations are tested may effect the accuracy of the testing process. In this manner, the method 100 tests all of the test configurations.

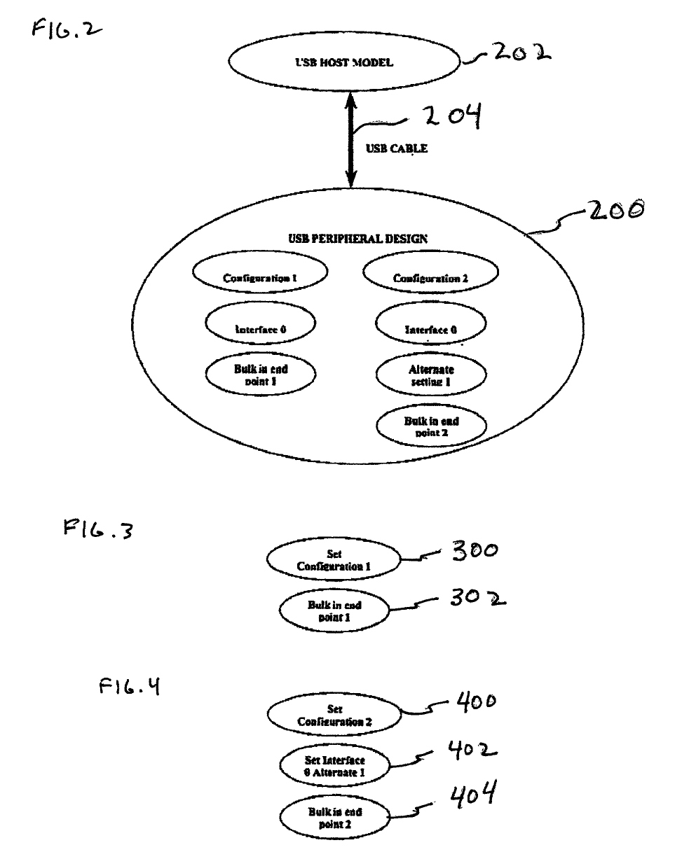

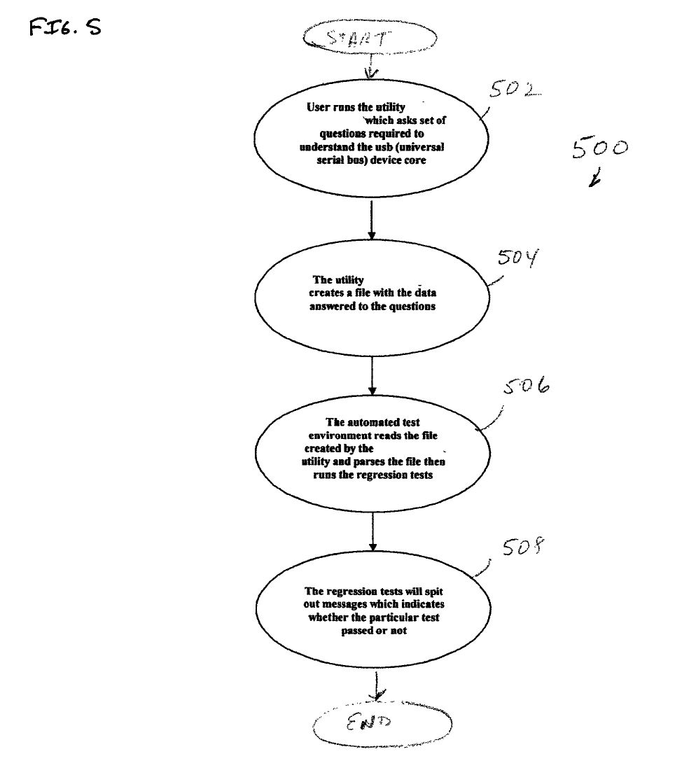

Referring now to FIG. 2, a USB peripheral design 200 has a bulk in end point whose number is 1 in a configuration one 1 and an interface 0. The design 200 is shown connected to a USB host model 202 through a USB cable 204. The design 200 has another bulk in end point 2 in a configuration 2, interface 0 and alternate setting 1. To test the bulk in end point 1, the method 100 in accordance with the present invention sets the configuration to 1 300 as shown in FIG. 3. Bulk in end point 1 is then tested 302. Referring to FIG. 4, after testing bulk in end point 1, the method 100 will set configuration to 2 at 400, set interface alternate to 1 at 402 and test bulk in end point 2 at 404. The present invention thus processes the USB peripheral design configuration information and tests all test configurations, or end points. The method 100 performs all setup transactions needed to enable each end point.

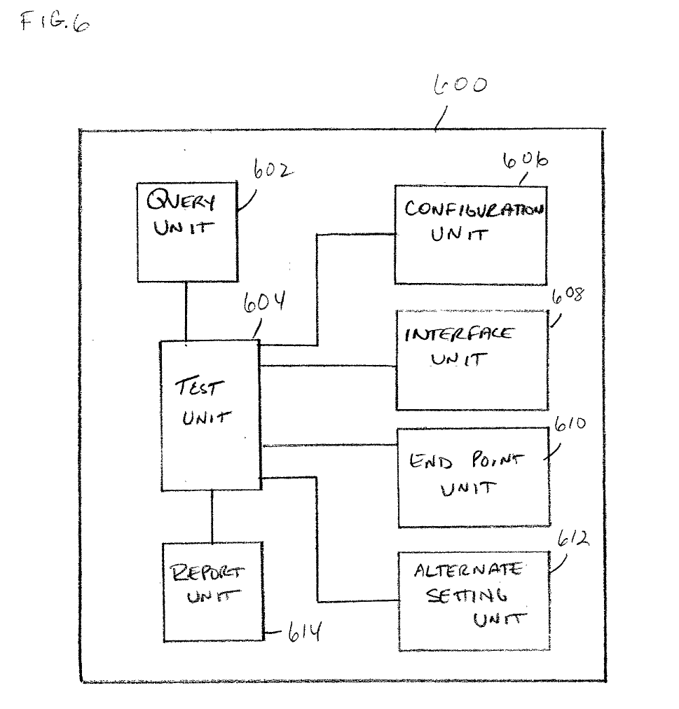

Referring now to FIG. 5, a flowchart generally illustrating the operation of the method 500 in accordance with an aspect of the present invention is provided. In the method 500, a user runs a utility which asks a set of questions required to understand the USB device core in step 502. The series of questions may be directed to any characteristic or information regarding the USB device core which is desired to test the USB device. In step 504, the utility creates a file with data corresponding to the answers given by the user. An automated test environment in accordance with the present invention reads the data, or a file containing the data, created by the utility and parses the file in step 506. Regression tests, or tests of the USB design for multiple configurations, are then run. The regression tests produce messages which indicate whether the test passed or not for a particular test configuration in step 508.

A block diagram showing an exemplary system 600 for testing a USB design is shown in FIG. 6. A query unit 602 asks a set of questions to a user regarding the USB design. This information is used by a test unit 604 for automatically testing the USB design for a plurality of test environments, or configurations. In particular, a configuration unit 606 sets a configuration for each test environment. An interface unit 608 sets an interface value for each test environment. An end point unit 610 sets an end point for each of the test environments. An alternate setting unit 612 sets an alternate setting value for each of the test environments. The test unit 604 receives the various values from the configuration unit 606, the interface unit 608, the end point unit 610 and the alternate setting unit 612 and tests the USB design based on these values. The test unit 604, the configuration unit 606, the interface unit 608, the end point unit 610 and the alternate setting unit 612 form a test configuration module. The test configuration module may be implemented using an appropriate software code. A report unit 614 receives test reports from the test unit 604 which are provided to the user.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modification, equivalents and alternatives falling within the spirit and scope of the invention as defined by the following appended claims.

What is claimed is:

1. A method for automatically testing a universal serial bus design comprising the steps of:
(a) automatically selecting one of a plurality of test environments;
(b) testing the universal serial bus design based on the selected one of the test environments; and
(c) repeating steps (a) and (b).

2. The method as recited in claim 1 wherein the step of (c) repeating steps (a) and (b) comprises the step of:
repeating steps (a) and (b) until the universal serial bus design has been tested for all of the plurality of test environments.

3. The method as recited in claim 1 wherein the step of (a) automatically selecting one of a plurality of test environments comprises the step of:
selecting one of a plurality of end points.

4. The method as recited in claim 3 wherein the step of (a) automatically selecting one of a plurality of test environments comprises the step of:
selecting one of the end points and an associate one of one or more configurations.

5. The method as recited in claim 1 comprising the step of:
reporting test results.

6. The method as recited in claim 5 wherein the step of reporting test results comprises the step of:
reporting test results substantially immediately if one of the selected test environments fails.

7. The method as recited in claim 5 wherein the step of reporting test results comprises the step of:
reporting test results after all of the test environments have been tested.

8. A method for automatically testing a universal serial bus design comprising the steps of:
querying a user for information regarding the universal serial bus design;
automatically selecting one of a plurality of test configurations for the universal serial bus design based on the information regarding the universal serial bus design;
testing the universal serial bus design for the selected one of the test configurations;
automatically selecting another one of the test configurations for the universal serial bus design; and
testing the universal serial bus design for the other one of the test configurations.

9. The method as recited in claim 8 wherein the step of automatically selecting one of the test configurations for the universal serial bus design comprises the steps of:
selecting an end point for the universal serial bus design;
selecting a configuration for the universal serial bus design; and
selecting an interface for the universal serial bus design.

10. The method as recited in claim 9 wherein the step of automatically selecting one of the test configurations for the universal serial bus design comprises the step of:
selecting an alternate setting for the universal serial bus design.

11. The method as recited in claim 10 comprising the step of:
reporting test results.

12. The method as recited in claim 11 wherein the step of reporting test results comprises the step of:
reporting test results substantially immediately if one of the selected test environments fails.

13. The method as recited in claim 11 wherein the step of reporting test results comprises the step of:
reporting test results after all of the test environments have been tested.

14. A system for testing a universal serial bus design comprising:
a query unit for querying a user for information regarding the universal serial bus design; and
a test configuration module for automatically testing the universal serial bus design for a plurality of test configurations based on based on the information regarding the universal serial bus design.

15. The system as recited in claim 14 wherein the test configuration module comprises a configuration unit for setting a configuration value for each of the test configurations.

16. The system as recited in claim 15 wherein the test configuration module comprises an interface unit for setting an interface value for each of the test configurations.

17. The system as recited in claim 16 wherein the test configuration module comprises an end point unit for setting an end point value for each of the test configurations.

18. The system as recited in claim 17 wherein the test configuration module comprises an alternate setting unit for setting an alternate setting value for each of the test configurations.

19. The system as recited in claim 18 comprising a report unit for reporting test results for the test configurations.

20. The system as recited in claim 18 comprising a report unit for reporting test results after each test configuration is tested.
